(19) United States
(12) Patent Application Publication
(10) Pub. No.: US 2022/0302530 A1
(43) Pub. Date: Sep. 22, 2022

(54) ELECTROCHEMICAL CONVERTER APPARATUS AND METHOD

(71) Applicant: Jinetics Inc., Santa Clara, CA (US)

(72) Inventors: Shicheng Xu, Palo Alto, CA (US); Jan Torgersen, Trondheim (NO)

(21) Appl. No.: 17/205,458

(22) Filed: Mar. 18, 2021

(51) Int. Cl. H01M 50/102

(52) U.S. Cl. CPC H01M 50/102

(57) ABSTRACT

Aspects of the disclosure are directed to apparatuses and methods therefor, involving electrochemical conversion. As may be implemented in accordance with one or more embodiments, an apparatus includes an enclosure, an electrochemical converter and an end plate. The electrochemical converter has a membrane between respective electrodes and is configured to convert between a chemical material and energy. The end plate is coupled to the enclosure via an interference fit and forms a chamber with the enclosure and encloses the electrochemical converter. The end plate is configured to/used to apply compressive force to the electrochemical converter, via the interference fit.

### BACKGROUND

A variety of types of electrochemical converters, such as fuel converters, are based on polymer electrolyte membranes. These membranes may be compressed with respective electrodes to ensure electricity conductance and gas transport for efficient operation. For example, a hydrogen fuel cell may be compressed by attaching fasteners through end plates and/or with compression systems attached to the periphery of the device.

While useful, the application of electrochemical converters may be challenging to implement in a desirable manner. For instance, compression mechanisms may require relatively thick or stiff end plates for applying uniform compression, which may lead to local over-compression around fastener positions, and/or to insufficient compression around electrochemically effective areas. Further, certain components used to achieve desirable compression may be bulky, and thus challenging to utilize in certain applications.

These and other matters have presented challenges to the implementation of electrochemical converters, for a variety of applications.

### SUMMARY

Various example embodiments are directed to electrochemical converters, their application and their manufacture. Such embodiments may be useful for converting between chemical material and energy, with various aspects utilizing a pressure fit to apply and maintain compressive force upon electrochemical converter componentry.

As may be implemented in accordance with one or more embodiments, an apparatus comprises an enclosure, an electrochemical converter and an end plate. The electrochemical converter has a membrane between respective electrodes and is configured to convert between a chemical material and energy. The end plate is coupled to the enclosure via an interference fit, with the end plate and the enclosure forming a chamber that encloses the electrochemical converter. The end plate is further configured to apply compressive force to the electrochemical converter, via the interference fit.

Another embodiment is directed toward a method as follows. An electrochemical converter is positioned within a provided enclosure, in which the electrochemical converter has a membrane between respective electrodes and is configured to convert between a chemical material and energy. An end plate is coupled to the enclosure via an interference fit and used with the enclosure to form a chamber that encloses the electrochemical converter. The end plate further applies compressive force to the electrochemical converter via the interference fit.

Another embodiments is directed to a method as follows. An electrochemical converter is positioned within a provided enclosure, and end plate is coupled to the enclosure via an interference fit and used with the enclosure to form a chamber that encloses the electrochemical converter and to apply compressive force to the electrochemical converter via the interference fit. The electrochemical converter has a membrane between respective electrodes convert between the chemical material and energy. In some implementations, the end plate includes a first one of the respective electrodes and is used to couple energy with the electrochemical converter.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description and in connection with the accompanying drawings, in which:

FIG. 1A shows an electrochemical converter apparatus, in accordance with one or more embodiments;

FIG. 1B shows a cross section of an example implementation of the apparatus depicted in FIG. 1A;

FIG. 2 shows an electrochemical converter apparatus with multiple electrochemical cells, as may be implemented in accordance with various embodiments;

FIG. 3 shows an enlarged view of an apparatus having an interference fit between a sidewall of an enclosure and an end plate; as may be implemented with one or more embodiments;

FIG. 4 shows an enlarged view of an apparatus having an interference fit between a sidewall of an enclosure and an end plate with a bevel that facilitates assembly; as may be implemented with one or more embodiments; and

FIG. 5 shows an enlarged view of an apparatus having an interference fit between a sidewall of an enclosure and an end plate having a porous structure therein; as may be implemented with one or more embodiments.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as may be used throughout this application is by way of illustration, and not limitation.

### DETAILED DESCRIPTION

Aspects of the present disclosure are believed to be applicable to a variety of different types of articles of manufacture, apparatuses, systems and methods involving electrochemical and energy conversion. In certain implementations, aspects of the present disclosure have been shown to be beneficial when used in the context of electrochemical cells, such as fuel cells. Various aspects may be implemented with interference-fit enclosures that apply compressive force to catalyst material therein. One or more electrochemical converters may be implemented as such, within an apparatus. While not necessarily so limited, an appreciation may be gained through a discussion of examples using such exemplary contexts.

According to various example embodiments, mechanical compression is applied and sustained in an electrochemical converter, utilizing an interference fitting between a metallic end plate and a hollow metallic enclosure. In connection with this approach, it has been recognized/discovered that an enclosure of this manner may be utilized to make small form factor converter cells. In connection with this recognition/discovery, this compression mechanism may facilitate a low-profile form factor (e.g., between 0.02 and 0.75) defined as the ratio between the thickness (the dimension parallel to the pressure) and the lateral dimension (the dimension perpendicular to the pressure), and an overall dimension below 25 mm thick. For instance, certain embodiments relate to a wearable electrochemical cell that can disperse chemical onto a local surface of the human body, taking advantage of low profile implementation.

In certain embodiments, the hollow metallic enclosure and/or end plate may be utilized as an electrical-conducting electrode in the electrochemical converter. A porous structure or other opening or channel, for instance integrated with the enclosure and/or end plate, may allow passing of fluids such as reactants, products, catalysts and coolants that may affect and/or result from an electrochemical reaction within the converter.

In a particular embodiment, an apparatus includes an enclosure, electrochemical converter and end plate that is coupled to the enclosure via an interference fit, with the end plate and the enclosure forming a chamber that encloses the electrochemical converter. The electrochemical converter has a membrane between respective electrodes and is configured to convert between a chemical material and energy, for instance by using electricity to convert a chemical into to another chemical or by using a chemical to generate electricity (or both). The end plate applies compressive force to the electrochemical converter, via the interference fit. In certain implementations, the end plate acts as one of the electrodes (or a portion thereof), for coupling energy with the electrochemical converter.

The electrochemical converter may be implemented for a variety of types of energy conversion. For instance, proton transport may be effected in which a hydrogen source is associated with one electrode and a hydrogen receiver is associated with another electrode. Hydrogen sources implemented herein may include hydrogen containing molecules such as hydrogen gas, water, methanol, ethanol, methane, ethylene, and formic acid. In addition to reducing protons to hydrogen gas, hydrogen receivers may include molecules that can be reduced by hydrogen, such as dioxygen, dinitrogen, carbon dioxide, methanol, ethanol, and formic acid. Certain embodiments may utilize hydroxide ion transport in which a hydroxide ion source is associated with one electrode and a hydroxide ion receiver is associated with another electrode. Hydroxide ion sources may include water with oxygen. Hydrogen ion receivers may reduce hydroxide ions to oxygen and water, and may include substances that can react with hydroxide ions such as hydrogen gas, metal (e.g., Li, Zn, Fe, Al, and Sn) and metal ions.

Energy may be coupled in a variety of manners. In some embodiments, a potential difference is applied between the electrodes to apply current to react or otherwise affect chemical material. In other embodiments, a chemical reaction or other interaction is used to provide a potential between the electrodes, which in turn may be used to generate current. Certain apparatuses are configured for both energy generation and chemical conversion, via the extraction and/or application of electrical current.

The electrochemical converter may be implemented in a variety of manners. In some instances, the electrochemical converter includes first and second catalyst layers separated by a membrane, with a first electrode coupled to the first catalyst layer and a second electrode coupled to the second catalyst layer. In some instances, insulating material is provided in the chamber and arranged electrically insulate one or more electrodes, for example by insulating an electrode from the end plate and the enclosure for instances in which the end plate forms another one of the electrodes.

In certain embodiments, the apparatus passes fluid into and/or out of the chamber. For instance, the apparatus may include a porous structure to pass fluid material between the chamber and an environment exterior to the chamber, relative to an electrochemical reaction. In certain implementations, the end plate includes the porous structure. The enclosure and/or end plate may include one or more ports to pass chemical material between the chamber and an environment external to the chamber.

The enclosure and end plate may exhibit a low-profile form factor, defined as the ratio between a height of the apparatus in a direction parallel to the compressive force and a width of the apparatus in a direction perpendicular to the compressive force, having a value between 0.02 and 0.75.

Another embodiment is directed toward a method of manufacturing an apparatus, in which an electrochemical converter is positioned within an enclosure, and an end plate is coupled to the enclosure via an interference fit and used with the enclosure to form a chamber that encloses and applies compressive force to the electrochemical converter. The electrochemical converter has a membrane between respective electrodes and is configured to convert between a chemical material and energy. The electrochemical converter may include first and second catalyst layers separated by the membrane and respectively coupled to first and second electrodes. The first electrode may be provided with the end plate, in which case insulating material may be positioned in the chamber to electrically insulate a second one of the electrodes from the end plate and the enclosure. This approach may involve providing an electrochemical converter apparatus having a low-profile form factor, defined as the ratio between height and width of the enclosure with the end plate coupled thereto. The height may be in a direction parallel to the compressive force and the width perpendicular to the compressive force, with the ratio being between 0.02 and 0.75.

The positioning the electrochemical converter and coupling the end plate to the enclosure (with related application of compressive force) may configure the electrochemical converter to apply electricity to convert a chemical into to another chemical, use a chemical to generate electricity, or a combination thereof.

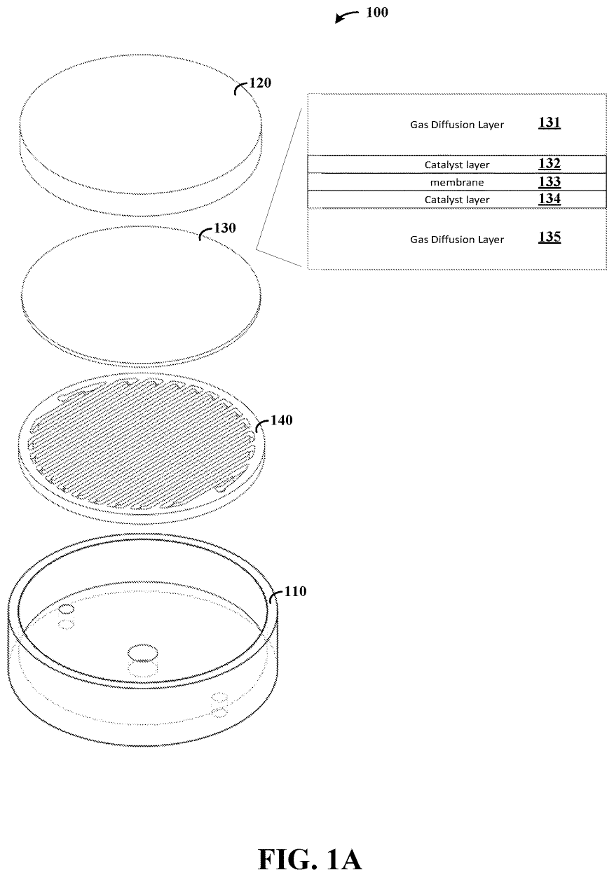

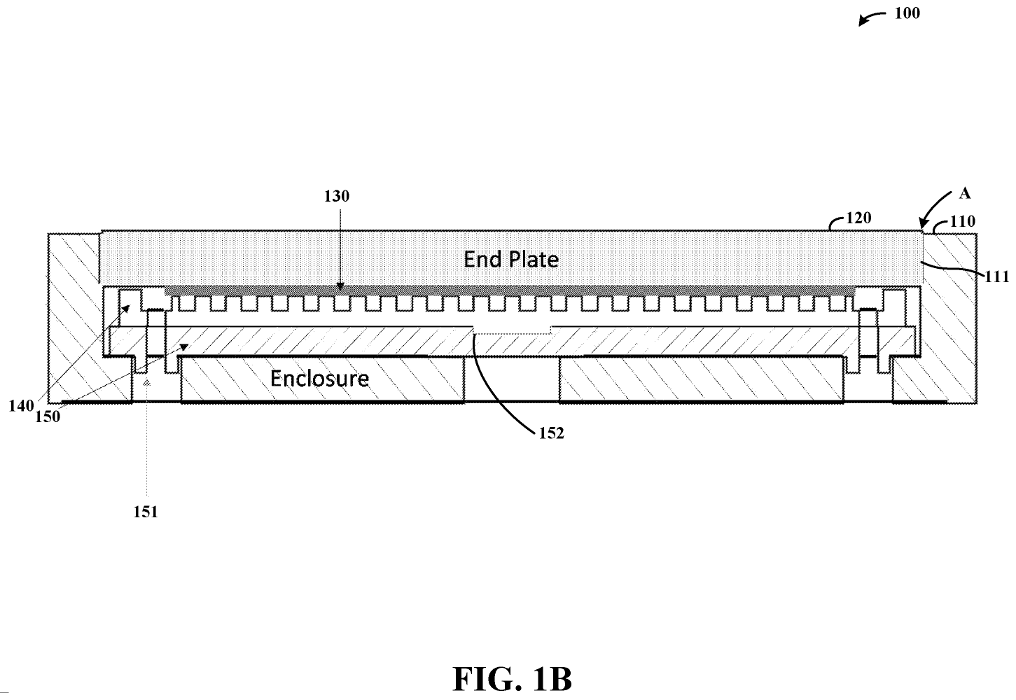

Turning now to the Figures, FIG. 1A shows an electrochemical converter apparatus 100, as may be implemented in accordance with one or more embodiments. The apparatus 100 includes an enclosure 110 (e.g., a conductive enclosure), an end plate 120 (as may also be conductive), and one or more electrochemical converter cells, each cell depicted by way of example as including a membrane electrode assembly 130 and a flow field containing electrode 140. In some embodiments, the membrane electrode assembly 130 includes a gas diffusion layer 131, catalyst layer 132, membrane 133, catalyst layer 134 and gas diffusion layer 135, shown as a cross-section portion of the assembly in an inset view. The catalyst layers 134 may be implemented with catalyst-coated electrodes.

The flow field containing electrode 140 can be single sided for a single cell device and double sided as a bipolar plate for multi-cell devices, and may be used to direct fluid flow for exposure to the catalyst containing electrodes. The membrane 133 in the membrane electrode assembly 130 may utilize an electrolyte membrane in which charge carrying ions may be selectively conducted, with catalyst containing electrodes 132/134 on either end of the membrane. The catalyst containing electrodes may include an electrically conductive, gas or liquid permeable thin layer, and may be porous. For example, in an embodiment of an electrochemical fuel-to-electricity converter such as the hydrogen fuel cell, the membrane may be implemented with a polymeric proton exchange membrane and in which the catalyst containing electrode includes carbon-supported platinum nanoparticles on a porous carbon paper, for instance utilized as the gas diffusion layers 131/135. Hydrogen oxidation may be catalyzed at one end of the membrane 133 and oxygen reduction may be catalyzed at the other end. The electrode reactions permit a voltage difference at which electron flows can be realized/driven.

In another embodiment in which the apparatus 100 is an electrochemical electricity-to-fuel converter such as an oxygen enrichment unit from air, the membrane 133 may include a polymeric proton exchange material, with the catalyst containing electrode on the cathode including carbon supported platinum nanoparticles on a porous carbon paper, and the catalyst containing electrode on the anode including iridium titanate on a porous titanium felt. Water may be oxidized to oxygen in the anode with proton released, which travels through the membrane and is consumed in a cathode reaction at which point oxygen from air is reduced. The overall reaction may include oxygen enrichment from one end of the membrane to the other, which may be driven by an externally applied electrical potential.

FIG. 1B shows a cross section of an example implementation of the apparatus depicted in FIG. 1A. A flow field assembly includes the flow field containing electrode 140 and a gasket 150 having protruded features 151 and a recess 152 that aligns to a protruded feature on the flow field electrode. The end plate 120 has an outer diameter greater than the inner diameter of the enclosure 110 at an intersection (A) thereof at which an interference fit is formed.

When assembling the cell, the end plate may be aligned with its peripheral in contact with an inner edge 111 of the enclosure. With the enclosure fixed, a mechanical pressure may be applied on the end plate to engage the edge of the end plate into that of the enclosure, The mechanical pressure for engagement can be applied, for example, using hydraulic pressure and/or by leveraging thermal expansion of the end plate and/or enclosure material, respectively. Proper alignment can be ensured using a geometric feature on the inner diameter of the enclosure and/or the outer diameter of the end plate, respectively, and may facilitate uniform application and maintenance of pressure.

After interference engagement, the enclosure 110 and the end plate 120 may be united to one electrical conductor. To apply an electric potential difference on electrochemical cells therein, electrical insulation may be made between the enclosure and the electrode closest to it. The insulation can be in a form of insulating coating or an insulating layer and may cover part of the electrode surface facing the enclosure, leaving an exposed area for electrical connections. An electrical potential can then be applied/extracted between the electrical connections attached to the enclosure and the electrode closest to it.

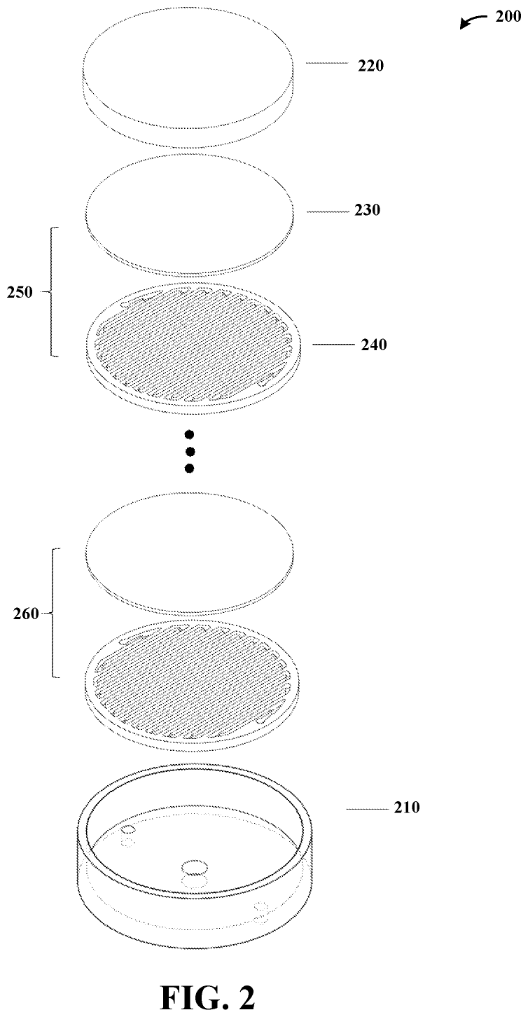

FIG. 2 shows an electrochemical converter apparatus 200 with multiple electrochemical cells each having a membrane/electrode pair, as may be implemented in accordance with various embodiments. The apparatus 200 includes an enclosure 210 and end plate 220 (interference fit with the enclosure upon assembly), and two or more electrochemical cells 250 and 260. By way of example, electrochemical cell 250 is depicted having a membrane assembly 230 and electrode 240. Additional such cells may be utilized within the apparatus 200, with related sizing and positioning of the end plate 220 to apply and maintain compression.

Accordingly, where a single cell is utilized, a porous metal piece can serve as both a flow field and end plate. Where multiple cells are used, respective porous structures can be utilized. In certain embodiments, through a porous design at the center of the end plate, the elastic modulus can be tuned to desired values for tailoring interference requirements and flow properties, respectively.

Certain multi-cell stacks utilize three-dimensional gas gaskets with individual fluid channels going through the membrane and insulated by the walls. Dedicated fluid channels may be provided for each single cell. This approach may facilitate tuning of reactant components in each individual cells as opposed to sharing reactants, and may address challenges relating to a gradient profile such as those in which cells closer to an inlet receive a higher concentration of reactants to be consumed. Furthermore, this approach may facilitate operation of different cells with different reactions. Protruded flow channels may serve as alignment marks during assembling.

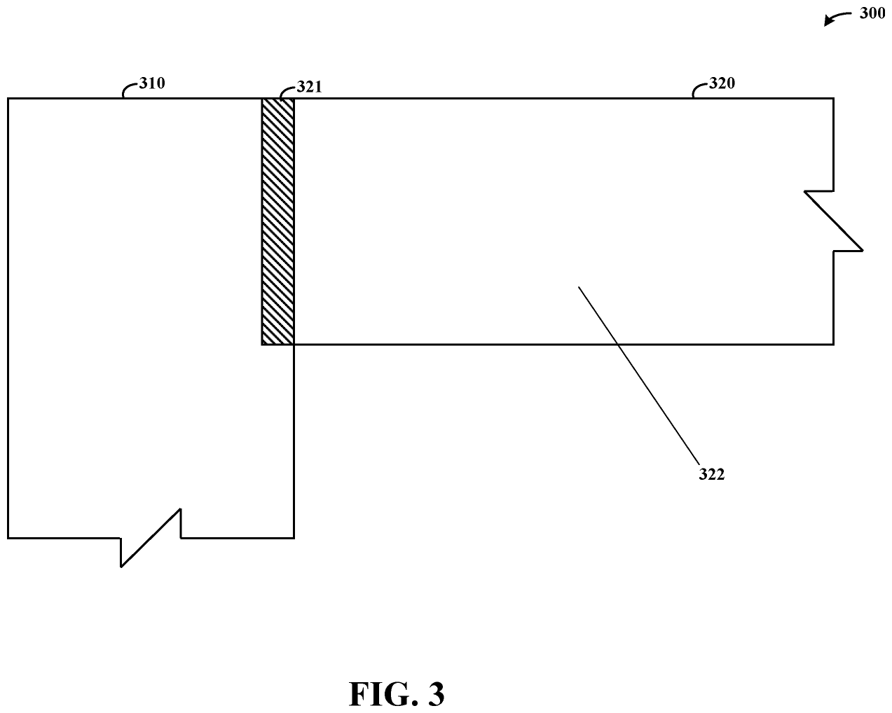

FIG. 3 shows an enlarged view of an apparatus 300 having an interference fit between a sidewall 310 of an enclosure and an end plate 320. An interference (cross-hatched) region 321 depicts a region of the interference fit, which may be controlled via the thickness of the material 322 utilized to form the end plate 320. For instance, the width of the interference (cross-hatched) region 321 may be 0.02-0.5 mm.

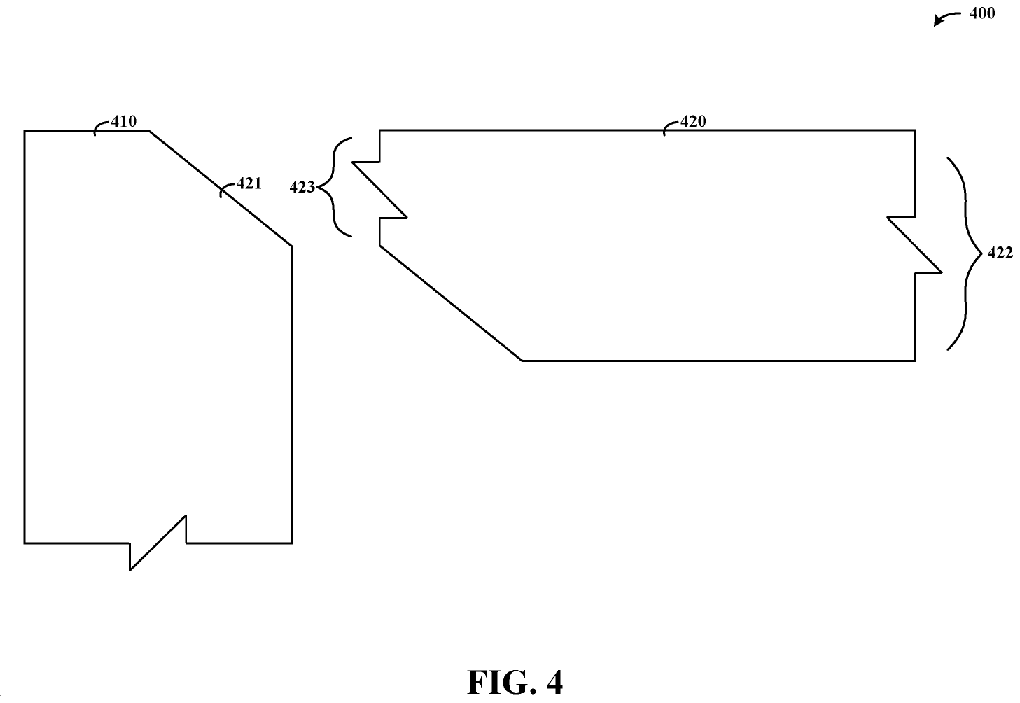

FIG. 4 shows an enlarged view of an apparatus 400 having an interference fit between a sidewall 410 of an enclosure and an end plate 420, with a bevel that facilitates assembly. The interference fit is along surface 421 and may be controlled via overall thickness 422 and thickness 423 of an interference region of the end plate 420.

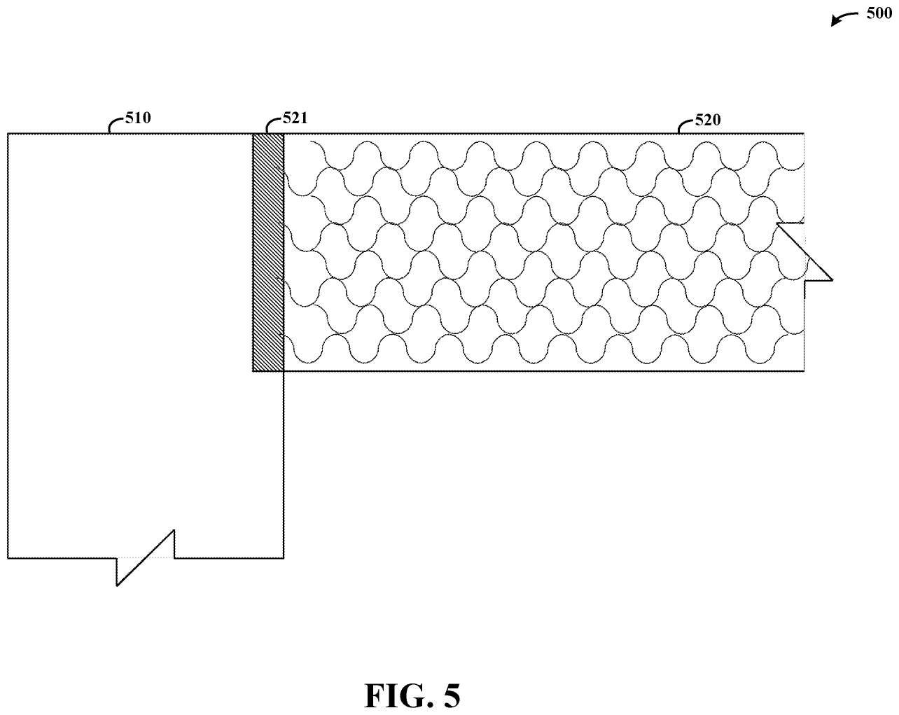

FIG. 5 shows an enlarged view of an apparatus 500 having an interference fit between a sidewall 510 of an enclosure and an end plate 520 having a porous structure therein. The cross-hatched region 521 depicts a region of the interference fit, which may be controlled via the thickness of the material end plate 520.

Based upon the above discussion and illustrations, those skilled in the art will readily recognize that various modifications and changes may be made to the various embodiments without strictly following the exemplary embodiments and applications illustrated and described herein. For example, while oxygen enrichment and hydrogen-to-electricity are noted herein, a variety of similar approaches may be used, with different catalysts, electrodes, flow field, and membranes. Such modifications do not depart from the true spirit and scope of various aspects of the invention, including aspects set forth in the claims.

What is claimed is:

1. An apparatus comprising:
an enclosure;
an electrochemical converter having a membrane between respective electrodes and being configured to convert between a chemical material and energy; and
and end plate coupled to the enclosure via an interference fit, the end plate and the enclosure forming a chamber that encloses the electrochemical converter, the end plate being configured to apply compressive force to the electrochemical converter, via the interference fit.

2. The apparatus of claim 1, wherein:
the electrochemical converter includes first and second catalyst layers separated by the membrane;
a first one of the electrodes is coupled to the first catalyst layer; and
a second one of the electrodes is coupled to the second catalyst layer.

3. The apparatus of claim 1, wherein the end plate includes a first one of the respective electrodes and is configured to couple energy with the electrochemical converter.

4. The apparatus of claim 3, further including insulating material in the chamber, the insulating material being configured to electrically insulate a second one of the respective electrodes from the end plate and the enclosure.

5. The apparatus of claim 1, including a porous structure configured to pass fluid material between the chamber and an environment exterior to the chamber, relative to an electrochemical reaction.

6. The apparatus of claim 5, wherein the end plate includes the porous structure.

7. The apparatus of claim 1, wherein the enclosure and end plate exhibit a low-profile form factor defined as the ratio between a height of the apparatus in a direction parallel to the compressive force and a width of the apparatus in a direction perpendicular to the compressive force, the ratio being between 0.02 and 0.75.

8. The apparatus of claim 1, wherein the electrochemical converter is configured to use electricity to convert a chemical into to another chemical.

9. The apparatus of claim 1, wherein the electrochemical converter is configured to use a chemical to generate electricity.

10. The apparatus of claim 1, wherein the electrochemical converter is configured to:
use electricity to convert a chemical into to another chemical; and
use a chemical to generate electricity.

11. The apparatus of claim 1, wherein the enclosure includes a port configured to pass chemical material between the chamber and an environment external to the chamber.

12. The apparatus of claim 1, wherein the end plate includes a port configured to pass chemical material between the chamber and an environment external to the chamber.

13. The apparatus of claim 1, wherein the electrochemical converter is configured to convert between fuel and energy.

14. A method comprising:
providing an enclosure;
positioning an electrochemical converter within the enclosure, the electrochemical converter having a membrane between respective electrodes and being configured to convert between a chemical material and energy; and
coupling an end plate to the enclosure via an interference fit, the end plate and the enclosure forming a chamber that encloses the electrochemical converter, and applying compressive force to the electrochemical converter via the interference fit.

15. The method of claim 14, wherein:
the electrochemical converter includes first and second catalyst layers separated by the membrane;
a first one of the electrodes is included in the end plate and coupled to the first catalyst layer; and
a second one of the electrodes is coupled to the second catalyst layer.

16. The method of claim 14, wherein the end plate includes a first one of the electrodes, further including providing insulating material in the chamber and positioning the insulating material being to electrically insulate a second one of the electrodes from the end plate and the enclosure.

17. The method of claim 14, wherein coupling the end plate to the enclosure includes providing an electrochemical converter having low-profile form factor defined as the ratio between a height and width of the enclosure with the end plate coupled thereto, the height being in a direction parallel to the compressive force and the width being perpendicular to the compressive force, the ratio being between 0.02 and 0.75.

18. The method of claim 14, wherein positioning the electrochemical converter and coupling the end plate to the enclosure includes configuring the electrochemical converter to convert between the chemical material and energy by using a conversion activity selected from the group of: using electricity to convert a chemical into to another chemical, using a chemical to generate electricity, and a combination thereof.

19. A method comprising:
providing an enclosure;
positioning an electrochemical converter within the enclosure, the electrochemical converter having a membrane between respective electrodes;
coupling an end plate coupled to the enclosure via an interference fit, the end plate and the enclosure forming a chamber that encloses the electrochemical converter, and applying compressive force to the electrochemical converter via the interference fit; and
using the electrochemical converter and applied compressive force to convert between chemical material and energy.

20. The method of claim 19, wherein the end plate includes a first one of the respective electrodes, wherein using the electrochemical converter to convert between the chemical material and energy includes using the end plate to couple energy with the electrochemical converter.
